(19) United States
(12) Patent Application Publication
(10) Pub. No.: US 2012/0231447 A1
(43) Pub. Date: Sep. 13, 2012

(54) Surface Passivation Methods for Single Molecule Imaging of Biochemical Reactions

(75) Inventors: Zhengjian Zhang, Ashburn, VA (US); Andrey Revyakin, Ashburn, VA (US); Steve Chu, Chevy Chase, MD (US); Robert Tijan, Berkeley, CA (US)

(73) Assignee: HOWARD HUGHES MEDICAL INSTITUTE, Chevy Chase, MD (US)

(21) Appl. No.: 13/397,423

(22) Filed: Feb. 15, 2012

Related U.S. Application Data
(60) Provisional application No. 61/443,016, filed on Feb. 15, 2011.

(51) Int. Cl. B05D 1/36; C07F 7/12; B05C 11/00; G01N 21/64

(52) U.S. Cl. 435/6.1; 556/452; 427/402; 118/73

(57) ABSTRACT

The present disclosure provides methods for treating a surface for single-molecule imaging.

### CROSS-REFERENCE TO RELATED APPLICATIONS

This application claims benefit under 35 U.S.C. §119(e) to U.S. Application No. 61/443,016 filed Feb. 15, 2011. The prior application is incorporated by reference herein in its entirety.

### TECHNICAL FIELD

The present disclosure relates to the use of reagents for the treatment of surfaces for single molecule imaging.

### BACKGROUND

Imaging biochemical reactions at the single molecule resolution has a huge impact on basic research and has great potential in new diagnostic approaches. Single-molecule reactions are usually carried out in optically transparent chambers, frequently made of glass. Although convenient for imaging, glass surfaces are well known for their ability to absorb organic molecules and bio-molecules non-specifically, thus reducing the availability and activity of these molecules.

In addition, single-molecule imaging frequently involves immobilization of biological molecules on a surface (to restrict their Brownian motion) and optically detecting the biological molecules (for example, through fluorescent tags or through macroscopic tags, such as magnetic or dielectric beads). In the case of fluorescently labeled molecules, single-molecule imaging requires that the density of immobilized molecules is roughly less than one fluorescent molecule per square micron (the approximate resolving power of optical microscopes). Thus, non-specific adsorption of fluorescent molecules to the surface increases the background noise and interferes with the signal from the specifically immobilized molecules (see, for example, FIG. 1).

Furthermore, performing single-molecule reactions with surface-immobilized components (e.g., monitoring interactions of a DNA-binding protein with a surface-immobilized DNA through fluorescence detection or optical/magnetic tweezers) dramatically increases the probability of inactivation of the reagents by the surface due to repetitive interactions between the tethered molecule and the surface. This puts the requirement for the glass surface passivation quality to a level much higher than is required for methods that do not involve immobilization of molecules.

Finally, with the expansion of the single-molecule methods into complex, poorly controlled biological systems (for example, detection of antigens in cell extracts or blood samples), the robustness of existing surface passivation methods, optimized for simple systems involving only one or a few components, is likely to be challenged.

Current imaging surface passivation methods (e.g., polyethylene glycol (PEG)-based protocols) are not suitable for complex biological systems due, at least in part, to surface fouling and the resulting effects. Accordingly, there is a need for surface passivation methods that address surface fouling and/or increasing imaging resolution to allow for single molecule imaging of biochemical reactions.

### SUMMARY

The present disclosure provides, inter alia, methods of passivating a surface, e.g. surface or coverslip) for single molecule imaging by treating the surface with an organosilane/siloxane solution. The passivating methods described herein can optionally include the use of anti-fouling and blocking reagents to preserve the surface after treatment with the organosilane/siloxane solution.

In one aspect, a method for passivating a surface for single molecule imaging is described. Such a method typically includes contacting the surface with an effective amount of a hydrophobic organosilane/siloxane for a time sufficient to passivate the surface for single molecule imaging. Representative surfaces include a slide, coverslip, plate, chip, sphere, microparticle, bead, microwell, and microfluidic device.

Representative hydrophobic organosilane/siloxane include, without limitation, 1,7-dichlorooctamethyltetrasiloxane, tert-butyltrichlorosilane, 1,3-dichlorotetramethyldisiloxane, butyltrichlorosilane, dichlorodimethylsilane, trimethylchlorosilane, butyltrichlorosilane, tert-butyltrichlorosilane, octadecyltrichlosilane, dichlorodimethylsilane, and 1,5-dichlorohexamethyltrisiloxane. In some embodiments, the hydrophobic organosilane/siloxane is 1,7-dichlorooctamethyltetrasiloxane. In some embodiments, the effective amount of the hydrophobic organosilane/siloxane is about 1% to about 50% in solution. In some embodiments, the time sufficient to passivate the surface for single molecule imaging is between 6 hours and 24 hours.

Such a method also can include contacting the surface with a blocking reagent. Representative blocking reagents include Tween20, Triton X-100, bovine serum albumin, lysozyme, non-fat milk, serum extracts, and cellular extracts.

In another aspect, a method of imaging a biochemical reaction is provided. Such a method typically includes contacting an imaging surface with an effective amount of a hydrophobic organosilane/siloxane for a time sufficient to passivate the surface for single molecule imaging; attaching at least a first component of the biochemical reaction to the surface; reacting at least the first component of the biochemical reaction with a second component; and imaging the biochemical reaction.

In some embodiments, the surface is further treated with a blocking reagent prior to attaching the first component. In some embodiments, the first component of the biochemical reaction is attached to the imaging surface through a covalent linkage. A representative covalent linkage is a bond between biotin and streptavidin. In some embodiments, the surface comprises biotin and the first component comprises streptavidin. In some embodiments, the second component includes a detectable label. Representative detectable labels include, without limitation, fluorophores, fluorescent proteins, quantum dots, metal nanoclusters and macroscopic tags. In some embodiments, the detectable label is a fluorophore.

In some embodiments, the biochemical reaction is imaged using a method such as epifluorescence microscopy, confocal microscopy, total-internal-reflection fluorescent microscopy, pseudo-total internal-reflection fluorescent microscopy, zero-mode waveguide-based imaging, near-field optical microscopy, bright-field microscopy, super-resolution microscopy, and atomic force microscopy

In some embodiments, the first component is nucleic acids and the second component is human RNA Polymerase II (Pol II).

In still another aspect, a kit for use in a method for single molecule imaging of a biochemical reaction is provided. Such a kit typically includes a hydrophobic organosilane/siloxane and instructions for using an effective amount of the hydrophobic organosilane/siloxane for a time sufficient to passivate a surface for single molecule imaging. Such a kit can further include a solid surface.

Other features and advantages will be apparent from the following detailed description and figures, and from the claims.

### DESCRIPTION OF DRAWINGS

FIG. 1 demonstrates the importance of surface passivation methods to preserve the biological activity of molecules for single molecule imaging, particularly when the biological molecule is immobilized on an imaging surface. The proximity of the surface to the immobilized molecule increases the probability of inactivation of the molecule due to non-specific adsorption to the surface. The difference in the probability of inactivation between molecules immobilized within 100 nm distance from the surface (required for some single molecule imaging technique such as TIRF) and molecules freely diffusing between two parallel cover slips separated by 0.1 mm or more (common for optical imaging, which has a high surface/volume ratio) is estimated to be in the order of a million based on the diffusion equation in the insert.

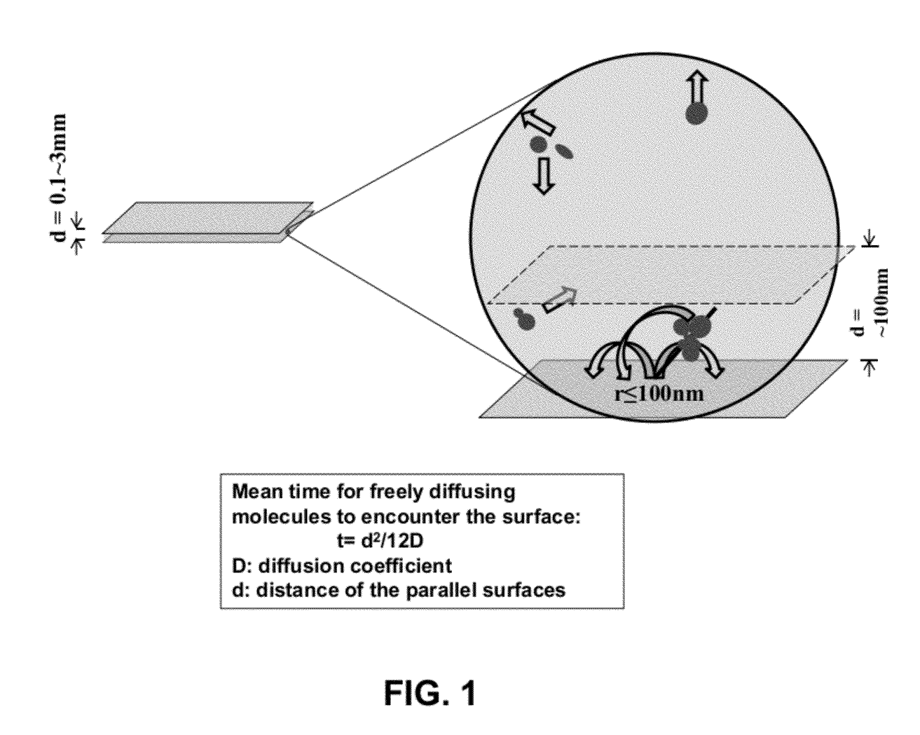

FIG. 2 demonstrates the elimination of fluorescent background imparted by the passivation methods disclosed herein. Images exposed to 532 nm laser illumination showing non-specific fluorescence before (left) and after (right) overnight photo bleaching under 2 W 532 nm laser (expanded to 10 mm in diameter).

FIG. 3 shows the results of a “stickiness test” comparing a standard PEG-functionalized surface and a passivated surface as described herein. 10 nM Escherichia coli RNA polymerase fluorescently labeled with Alexa555, and RNA-binding protein U1A labeled with Cy3 were used as examples, and their binding to the surface were monitored under the microscope. White spots represent individual protein molecules non-specifically binding to the surface.

FIG. 4A-C demonstrates the activity decay of a human RNA polymerase II transcription mixture (a complex biochemical reaction composed of more than 40 polypeptides) between regular PEG surfaces (Panel B) or PEG surfaces passivated as described herein (Panel C). Panel A depicts the design of the machine used to measure the biochemical activity decay. 80 μl of transcription reaction mixture was injected between two cover slips (25×40 mm) and incubated at 30° C. for the time specified. Complexes were then recovered for a standard activity assay with a reporter DNA template. Decay in test tubes was used as a control; no significant loss of the biochemical activity was observed in the test tube.

FIG. 5 shows the results of a transcription assay of surface-immobilized DNA templates. Panel A depicts the design and assembly of the “single-molecule biochemistry chamber” allowing the immobilization and counting of the DNA template molecules, transcription of these templates on a surface, and recovery of the products for a standard quantitative analysis. Panel B (top) shows the representative images of 100 μm² areas with fluorescently labeled DNA templates immobilized at certain densities on surfaces treated with PEG only or PEG followed by passivation with a hydrophobic siloxane. The numbers obtained from counting the whole area of 10,000 μm₂ (one microscopic field of view) was used to extrapolate the total amount of DNA template immobilized in the chamber with an inside surface of 10 cm² (“N_{DNA}” on the bottom). Transcription products from defined amount of DNA templates immobilized on the surfaces (bottom left) or freely diffusing in control tubes (bottom right) were detected and are shown on the bottom. As explained in FIG. 1, the immobilized template assay requires the reaction to occur very close to the surface and is, by far, the most stringent test of the quality of surface passivation.

### DETAILED DESCRIPTION

### Surface Treatment and Modification

The present disclosure features new methods for passivating a surface for single molecule imaging. The passivation methods described herein include treatment of the surface with a hydrophobic organosilane or a hydrophobic organosiloxane and may further include treatment with a blocking reagent. The surface passivation methods described herein are performed prior to immobilization of a biomolecule (e.g., nucleic acids or proteins) onto the surface for subsequent imaging. For example, in some embodiments, the passivation methods are performed by contacting a surface with a hydrophobic organosilane/siloxane solution for a sufficient time such that the surface, with respect to imaging properties and supporting the activity of the biomolecule, is superior to existing methods. The methods described herein preserve the biological activity of the immobilized molecule.

The surfaces provided by the methods described herein provide numerous advantages for applications involving surface-bound biochemical reactions. In some embodiments, the methods described are useful in preparing the surface for complex biological reactions where high signal-to-noise ratios are important, e.g. single molecule detection. In addition, the methods described herein result in surfaces that are resistant to fouling (i.e., contamination due to non-specific interactions with biomolecules). In situations in which detection of biomolecules is conducted through fluorescence, the anti-fouling benefit is important for imaging at the single-molecule resolution because it significantly reduces non-specific background.

By virtue of the design, the passivating methods described herein possess several advantages and benefits. For example, the surfaces prepared by the passivation methods described herein allow for the specific immobilization of one or more molecules of interest on the surface for single molecule imaging. In addition, after treatment with the passivation methods described herein, the imaging of biological reactions can be performed at higher resolutions, e.g. beyond the diffraction limit with computer processing, than previously obtained. Further, the methods described herein preserve the biological activity of the molecule, once immobilized on the surface, while being resistant to fouling. This is particularly important for complex processes, e.g. RNA Polymerase II (Pol II) in vitro transcription, because loss of activity of any one component can significantly compromise the performance of the transcription system. Additionally, since the treatment described herein significantly reduced fouling, this method is critical for imaging at the single-molecule resolution because it reduces the presence of non-specific background. It would be understood by those skilled in the art that simple methods like wiping a silane or siloxane on a glass surface in open air leave the surface uneven and, thus, unacceptable for single-molecule imaging and also are insufficient because fouling is prevalent.

### Surfaces

Surfaces appropriate for use can be two- or three-dimensional, and can include a planar surface (e.g., a slide or coverslip) or can be shaped (e.g., a bead). Surfaces used in single molecule imaging often are silica-based glass (e.g., borosilicate glass, fused silica, or quartz). Other appropriate surfaces also can be treated with the passivation methods described herein provided the surface material is compatible with the surface chemistry disclosed herein and with the requirements for single molecule imaging.

### Cleaning of Surfaces

Silica-based substrates need to be free of any contaminants that can contribute to fluorescent background or that can prevent the surface from reacting with the passivation agent. Furthermore, the substrates must have maximal amount of reactive silanol (Si—OH) groups exposed. Typically, the first step of the cleaning process involves treatment with a strong oxidizing agent (such as, but not limited to, the Piranha solution (3:1 H₂SO₄:H₂O₂) or an oxygen plasma cleaner) for a time ranging from about 30 min to about 12 hours. The quality of the cleaning can be evaluated using optical fluorescent microscopy at the single-molecule sensitivity level in the visible spectrum. The surface should typically contain less than a single detectable fluorophore per 100×100 micron field of view. A typical second step is treatment with potassium hydroxide or sodium hydroxide for a period of time that is long enough to expose reactive silanol groups on the surface, but not too long so as to introduce a degree of roughness into the surface, which typically is incompatible with single molecule imaging.

In some embodiments, treatment with a 0.5 M solution of KOH can be performed (e.g., for 1 hour in an ultrasound water bath), and the roughness of the surface can be estimated, for example, by bright field imaging or atomic force microscopy. An acceptable surface should have little to no defects visible with bright field imaging, and should have a roughness of no more than the depth of the evanescent field (if evanescent field-based detection methods such as total internal reflection fluorescence (TIRF) are used).

### Functionalization of the Surface

In some embodiments, a surface can be functionalized prior to passivation to allow specific immobilization of biomolecules for single-molecule imaging. If immobilization of a biomolecule is not necessary, the functionalization step can be omitted. Cases not requiring surface functionalization may be, but are not limited to, imaging of freely diffusing single molecules “in bulk”, or preparation of surfaces that are a part of the imaging chamber, but will not be imaged through (for example, the “top” coverslip of a chamber sandwich with imaging through the bottom).

Surfaces can be functionalized by attaching, either covalently or through hydrogen bounds, an organosilane/siloxane. The leaving group of the organosilane/siloxane can be Cl—, C₂H_{S}O—, CH₃—O, and the functional group can be NH2-, epoxy, HS— or alkyne. Functionalization of the substrate with the organosilane/siloxane can be achieved by a variety of methods known in the field, such as, but not limited to, vapor-phase deposition, incubation in aqueous organosilane/siloxane solutions, incubation in an organic solvent (such as, but not limited to, ethanol, acetone, toluene, heptane, or hexane) for periods of time ranging, but not limited to, from 5 minutes to 24 hours, at temperatures ranging from ambient to 120° C. The functionalized substrate then can be rinsed with the same solvent, and optionally can be cured. The resulting organosilane/siloxane layer can be, for example, 1-10 silane/siloxane residues thick. The conditions for organosilane/siloxane modification are optimized as to minimize the amount of fluorescent background introduced, and not to introduce surface roughness incompatible with single-molecule imaging, and not to create a layer of the organosilane/siloxane of thickness incompatible with single-molecule imaging.

Subsequent attachment of the biomolecules can be via the functional group introduced through the organosilane/siloxane or via an appropriate linker such as PEG (e.g., a molecular weight of from 500 to 20000 Da). The linker can be bi-functional, with one reactive group designed to react with the functional group introduced via the organosilane/siloxane on the glass surface. The reactive group on the linker can be, without limiation, N-hydroxysuccinimide ester (reacts with NH₂—), maleimide (reacts with —SH), acrydite (reacts with —SH), OH— (reacts with expoxy), NH₂ (reacts with epoxy), or azide (reacts with alkyne). The second reactive group of the linker provides a way to attach the biomolecules of interest. For example, the second reactive group can be a biotin residue, which strongly interacts with streptavidin, or a N-hydroxysuccinimide ester, which reacts with amines in the lysines of proteins.

### Passivation of the Surface

Generally, surface passivation is achieved by deposition of hydrophobic organosilanes or hydrophobic organosiloxanes onto a cleaned surface (with or without functionalization). These hydrophobic organosilanes/siloxanes contain one or more functional group(s) (for example, Cl—, C₂H_{S}O—, and CH₃—O—) that allows their attachment to the surface through silanol groups or other groups introduced through the functionalization process, and one or more hydrophobic residue(s) (for example, an alkane, a fluoro-alkane, or a phenyl). In some embodiments, the hydrophobic organosilane/siloxane includes, but is not limited to: trimethylchlorosilane (CAS #75-77-4); butyltrichlorosilane (CAS #7521-80-4); tert-butyltrichlorosilane (CAS #18171-74-9); octadecyltrichlosilane (CAS #112-04-9); dichlorodimethylsilane (75-78-5); 1,3-dichlorotetramethyldisiloxane (CAS #2401-73-2); 1,5-dichlorohexamethyltrisiloxane (CAS #3582-71-6); or 1,7-dichlorooctamethyltetrasiloxane (CAS #2474-02-4).

A hydrophobic organosilane/siloxane can be applied to a surface through vapor deposition or deposition with at least one organic solvent. The mode of deposition, the duration of deposition, the nature of the solvent, the purity of the solvent, the temperature, and the catalyst, are optimized so as to maximize the activity of the biological molecule in contact with the surface, to minimize the amount of fluorescent background present (if fluorescence detection is the single-molecule imaging method of choice), to ensure that the surface is smooth enough to be compatible with single-molecule imaging, and to create a layer of organosilane/siloxane having a thickness that is compatible with single-molecule imaging (for example, less than 100 nm thick for TIRF imaging).

In some embodiments, the hydrophobic organosilane/siloxane is deposited using an anhydrous organic solvent such as, but not limited to, heptane, hexane, or toluene. The solvent used should be free of fluorescent contamination. Typically, a solvent of appropriate grade is used, or if necessary, the solvent can be redistilled before use and/or passed through a carbon, alumina or silica resin to eliminate fluorescent background (if fluorescence detection is the single-molecule imaging method of choice).

In some embodiments, the amount of hydrophobic organosilane/siloxane present in a solvent is about 1% to about 50% (e.g., about 1% to about 25%; about 1% to about 15%; about 2% to about 40%; about 3% to about 30%; about 4% to about 20%). In some embodiments, the amount of hydrophobic organosilane/siloxane present in a solvent is about 5% to about 25% (e.g., about 5% to about 20%; about 5% to about 15%; about 5% to about 10%). In some embodiments, the amount of hydrophobic organosilane/siloxane present in a solvent is about 5% (e.g., about 5% to about 10%). As used herein, the term “about” is +/−1%, +/−5%, or +/−10% of the recited value.

The surface is treated by contacting the surface with the organosilane/siloxane for a time sufficient to preserve the activity of the biomolecule that is immobilized onto the surface. For example, in some embodiments, the period of time that the surface is contacted with the organosilane/siloxane is between 1 hour and 3 days (e.g., between 1 hour and 30 hours, between 1 hour and 24 hours, between 5 hours and 20 hours, or between 10 hours and 15 hours). In some embodiments, the treatment period is between 3 hours and 30 hours (e.g., between 6 hours and 24 hours, between 12 hours and 24 hours, between 18 and 20 hours). In some embodiments, the treatment period is between 12 hours and 24 hours, for example, about 18 hours.

The contacting can be done at room temperature, but, in some embodiments, an elevated temperature (70-120° C.) can be used to accelerate the passivation process. In some embodiments, the surface can be contacted with the organosilane/siloxane under a vacuum. In some embodiments, a surface can be finished by applying heat after the surface has been contacted with the organosilane/siloxane solution. In some instances, a catalyst such as, without limitation, pyridine or diisopropyl-n-ethylamine, can be present.

For example, in one embodiment, a surface is incubated with a 5% solution of 1,5-dichlorohexamethyltrisiloxane in anhydrous toluene at 80° C. for 12 to 24 hours. In another embodiment, a surface is incubated with a 1% to 20% solution of 1,7-dichlorooctamethyltetrasiloxan in anhydrous heptane at room temperature for about 16 hours.

Following passivation of a surface as described herein, the surface can be rinsed, for example, with the solvent used for the organosilane/siloxane deposition or with acetone for about 5 minutes up to about 30 minutes or more. Surfaces treated with the passivation methods described herein can be used immediately or stored at 4° C. in a moist environment (e.g., in water).

Occasionally, surface passivation with a hydrophobic organosilane/siloxane can result in the presence of non-specific fluorescence background (e.g., upon excitation with a 532 nm laser and imaging in the 580/60 nm optical band). The impurities causing this non-specific fluorescent background can be reduced by passing the organosilane/siloxane and/or the respective solvent through an activated carbon, alumina or silica resin prior to its application on the surface. Such filtering methods are routine in the art. Optionally, a laser at a wavelength of interest can be used to “bleach” the glass surface after the passivation method is complete to further remove any remaining non-specific fluorescent background that remains after the passivation treatment. For example, bleaching a surface as described herein can lower the fluorescent background 10-fold. Those in the art would understand that, if the single molecule detection method does not involve fluorescence, the bleaching steps are not relevant.

### Blocking Reagents

In some embodiments, the passivation methods described include treatment of the surface with a blocking reagent (i.e., an anti-fouling reagent). A hydrophobic surface prepared as described herein is blocked very well with surfactant solutions or protein solutions. In some embodiments, a blocking reagent is pure, well-defined proteins. For example, bovine serum albumin (BSA) or lysozyme can be used for blocking a surface. In some embodiments, nonionic surfactants can be used as blocking reagents at a concentration of, for example, 0.1%. Nonionic surfactants include, for example, Triton X-100 (CAS #9002-93-1), Polyysorbate 20 (Tween 20; CAS #9005-64-5), and Saponin (CAS #8047-15-2). Typically, a blocking reagent is applied around five minutes prior to the using the surface for single-molecule imaging. In some embodiments, the blocking reagent remains present in the reaction buffer during the single-molecule imaging at concentrations compatible with the biological activity of interest.

### Immobilization of a Target Molecule on an Imaging Surface

The passivation methods described herein are compatible with routine modifications used for immobilization of biological molecules (e.g., nucleic acids or proteins). Various methods can be used to immobilize the target molecule to the passivated surface and can be achieved through either covalent or non-covalent interactions with the surface. In some embodiments, the biotin-streptavidin interaction is used to attach a target molecule to a surface. When a biotin-streptavidin linkage is used, the immobilized molecule contains a biotin residue introduced either chemically (e.g., a biotinylated nucleic acid or a protein biotinylated at lysine or cysteine residues), or through molecular genetic technology (e.g., a protein biotinylated in vivo).

In some embodiments, the digoxygenin-antibody interaction can be used to immobilize a biological molecule on an imaging surface. In this case, the immobilized molecule contains a digoxygeinin residue introduced either chemically (e.g., through a reaction of a N-hydroxysuccinimide derivative of digoxygeinin with an amine in the biological molecule), or by enzymatic incorporation (e.g., by polymerase chain reaction (PCR) amplification of a nucleic acid with a digoxygeinin-labeled nucleotide).

In some embodiments, immobilization is via a covalent linkage between a functional group on the biological molecule and a functional group on the surface. For example, in some embodiments the biological molecule is covalently attached to the surface through an amine on the biological molecule to an N-hydroxysuccinimide ester on the surface.

### Labelling the Target Molecule

In some embodiments, the biological molecules can be fluorescently labeled by covalent or non-covalent linkages. Methods of introducing fluorophores into biological molecules are well known and include, without limitation, direct chemical synthesis (for nucleic acids and small peptides), incorporation using enzymatic reactions (e.g., amplification of nucleic acids by PCR using labeled oligonucleotide primers or labeled nucleotide triphosphates), molecular cloning technologies (e.g., by expression of a chimeric protein fused to a fluorescent protein), chemical labeling of natural amino acids (e.g., labeling of cysteine or amine residues in a protein with a maleimide or N-hydroxysuccinimide derivative of the fluorophores), chemical labeling of non-natural amino acids (Ambrx), labeling through a specifically-introduced protein tag (such as “Snap” tag (New England Biolabs) or “Halo” tag (Promega)), labeling via an antibody-antigen interaction, and labeling through biotin-streptavidin interactions.

Fluorophores suitable for use in the methods disclosed herein are those that are suitable for single-molecule imaging. Fluorophores typically are selected based on their brightness and photostability, and common fluorophores include, without limitation, the cyanine family of dyes (GE Healthcare), the Alexa family of dyes (Invitrogen), the Atto family of dyes (ATTO-TEC GmbH), the DyLight family of dyes (Dyomics), the rhodamine family of dyes, derivatives of fluorescent proteins, functionalized fluorescent quantum dots (Invitrogen), and functionalized metal nanoclusters.

In some embodiments, the biological molecules can be labeled with microscopic tags that do not require fluorescence to be detected. Such microscopic tags include, for example, beads with diameters of 0.5-5 microns. Such beads can be attached to nucleic acid molecules or proteins, and can be used to manipulate biological molecules and to detect activity of biological molecules (e.g., through optical or magnetic tweezers).

### Methods of Imaging the Immobilized Target Molecule

The passivation methods described can be used to improve the current imaging techniques for single-molecule detection. Methods of single-molecule imaging include, without limitation, epifluorescence microscopy, confocal microscopy, TIRF and pseudo-TIRF (with illumination achieved for example, through a prism, or through the imaging objective), zero-mode waveguide-based imaging, near-field optical microscopy, bright-field microscopy (with microscopic tags used as labels), super-resolution microscopy (PALM/STORM, STED), and atomic force microscopy.

Detectors used in single molecule imaging can include CCD cameras, back-illuminated CCD cameras, scientific CMOS cameras, intensified CCD cameras, avalanche photodiodes, and photodiode arrays. Light sources used for single-molecule imaging include, for example, continuous-wave lasers, pulsed lasers, light-emitting diodes, tungsten and mercury lamps.

When fluorescence is used as the readout signal, fluorescence intensity and/or fluorescent lifetime can be used as the observable signals. The resulting signals can be analyzed manually or using appropriate computer software.

### Characteristics of a Passivated Surface

A surface passivated using the methods described herein can be characterized using a rapid “stickiness test” with one or more test proteins. Representative test proteins include, for example, Escherichia coli RNA polymerase (e.g., fluorescently labeled with Alexa 555), RNA-binding protein U1A (e.g., labeled with Cy3), and Tet repressor protein (e.g., labeled with TMR). For example, an imaging chamber can be assembled using a substrate passivated as described herein, and a 10 nM solution of the test protein in imaging buffer can be injected into the chamber. The interactions of the protein with the surface can be monitored in real time with TIRF. An acceptably passivated surface as described herein displays less than fifty “spots” of the test protein (i.e., when at equilibrium with the test protein).

In addition, a biochemical activity decay test can be carried out to determine the lifetime of active biological molecules in the imaging chamber. These results then can be compared to the lifetime of active biological molecules under well-defined conditions (e.g., activity in a test tube). For example, a known volume of a reaction mixture containing the biological molecule is incubated between two passivated coverslips at a surface-to-volume ratio that is similar to or identical to the conditions of a single-molecule reaction. The reaction mixture then can be recovered at defined intervals (on a time scale similar to a single-molecule reaction), and the remaining biological activity can be assayed using radioactivity-based biochemical assays. In parallel, the same volume of the reaction mixture can be incubated under conditions known to result in minimal activity loss (e.g. in solution in a polypropyelene microtube). An optimal surface passivation method is expected to result in activity decay rates on the surface that are comparable with the decay rates observed in optimal (test tube) conditions.

As a more stringent test of the surface passivation, an activity assay of the immobilized biological molecules can be carried out. For example, a known number of nucleic acid templates can be immobilized on a passivated surface within the imaging chamber, and the total number of immobilized templates counted using single-molecule imaging. Subsequently, the surface-immobilized nucleic acids are used as templates in a transcription reaction and the number of transcripts produced can be measured with standard radioactivity-based methods. In parallel, the same amount of nucleic acid is transcribed under conditions that result in maximal activity (e.g., in a polypropyelene microtube). The number of transcripts generated under the optimal conditions then can be compared to the number of transcripts generated from immobilized nucleic acid templates in the imaging chamber. A number of transcripts that is identical within experimental error (10-25%), indicates an acceptably passivated surface.

Unless otherwise defined, all technical and scientific terms used herein have the same meaning as commonly understood by one of ordinary skill in the art to which this invention belongs. Exemplary methods and materials are described herein; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

The invention is illustrated in part by the following examples, which are not to be taken as limiting the present disclosure in any way.

### EXAMPLES

### Example 1

### Passivation Methods

### Passivation Procedure

Borosilicate glass cover slips (VWR 48393 230) were placed in ceramic racks and treated with Piranha solution (3:1 H₂SO₄:H₂O₂) twice for 30 min, and rinsed with deionized water until pH had stabilized (according to an indicator paper test). H₂SO₄ was concentrated, and H₂O₂ was a 30% solution. The slides were then treated with 0.5 M potassium hydroxide for 1 hour in a ultrasound water bath and rinsed with deionized water until pH had stabilized (according to an indicator paper test).

The cleaned substrates were briefly rinsed with acetone and soaked in a 3% solution of aminopropyltriethoxysilane (APTES, CAS #919-30-2) in acetone for 45 min with shaking The substrates were then rinsed briefly with acetone, and rinsed copiously with deionized water. The substrates were then immediately blown dry with clean nitrogen. Functionalization of the APTES-modified slides was achieved by incubation of coverglasses with freshly prepared 10% solution of methyl-PEG-succinimidyl-valerate and biotin-PEG-succinimidyl-valerate (average molecular weight 5,000 Dalton, polydispersity index less than 1.1, 20:1 ratio of methyl-PEG to biotin-PEG) in 0.5 M K₂SO₄ at pH 9.0 for 15 min. Care was taken to ensure that the PEG solution remained at pH 9.0 for not more than several seconds before it was deposited onto the coverslips, due to the short (˜5 min) lifetime of the succinimidyl-valerate functional group at pH 9.0.

The functionalized cover slips were placed into 50 mL polypropylene tubes (Corning Inc. 430828) and rinsed with copious amounts of deionized water. The coverslips were then dried by spinning at 300 g in a swing-bucket centrifuge (Eppendorf® 5810R) and any residual water droplets were wiped off from the coverslip edges using Kimberly-Clark® KimWipes™. The coverslips were left at room temperature (approximately 40% relative humidity) for approximately 30 minutes. The coverslips were then soaked in a 5% solution of 1,7-dichlorooctamethyl-tetrasiloxane (Gelest Inc. SID3367.0-25GM) in anhydrous hexane at room temperature for 16 hrs. The siloxane solution was decanted and the coverslips were immediately rinsed with acetone twice. The coverslips were then incubated in acetone for five minutes with gentle shaking and then briefly rinsed with more acetone. The coverslips were then immediately rinsed with copious amounts of deionized water and stored in water at 4° C. until needed.

The protocol described above generates a highly hydrophobic glass surface. As an indication of the hydrophobicity of the glass surface, the coverslips appeared “dry” upon withdrawal from an aqueous solution. Water droplets will “bead up” upon deposition onto this surface and roll off the surface.

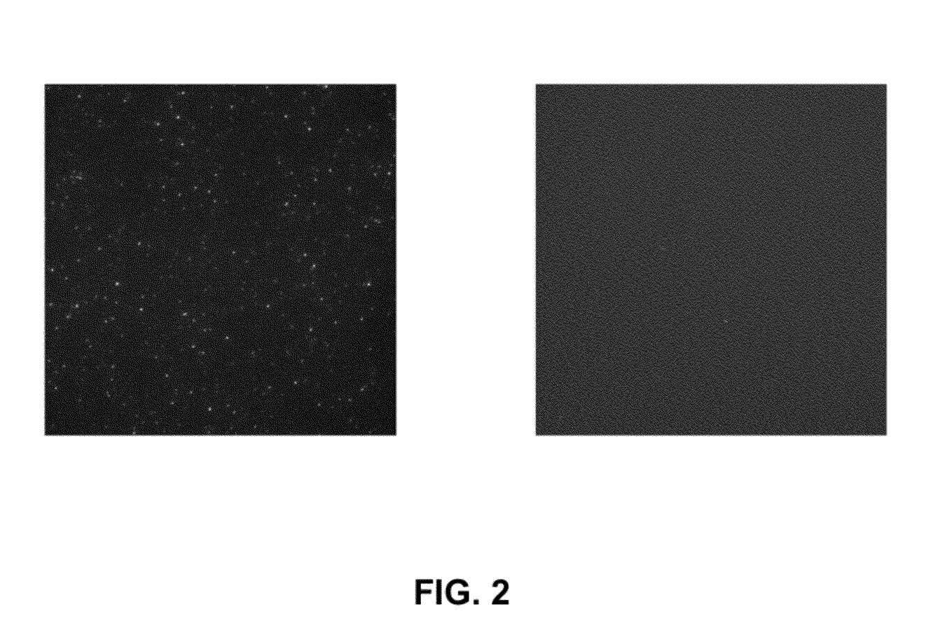

Incubation with 1,7-dichlorooctamethyltetrasiloxane can result in various amounts (depending on the supplier and the grade of the siloxane and the solvent used) of a non-specific fluorescent background upon excitation with a 532 nm laser line and imaging in the 580/60 nm optical band. To remove this background, illumination of the substrates with a 2 W 532 nm continuous-wave laser (beam expanded to 10 mm in diameter) for 16 hrs was sufficient. FIG. 2 demonstrates that the non-specific fluorescence background at 532 nm wavelength can be dramatically reduced after “bleaching” by such laser illumination.

### Example 2

### Characterization of Surface Passivation Using a “Stickiness Assay”

Glass coverslips (either modified with PEG alone, or with PEG followed by passivation with the hydrophobic siloxane) were prepared as described herein. An imaging “sandwich” flow cell was assembled using two coverslips and double-sided tape. Several “channels” were created with the double-sided tape to allow imaging of different test proteins on the same surface. Phosphate-buffered saline (pH 7.5) containing 0.1% Tween 20 (“PBST”) was injected into the channel and incubated for at least 5 min. As a first test protein, a 10 nM solution in PBST of E coli RNA polymerase holoenzyme labeled with Alexa555 at the sigma subunit was injected into the “channel”. As another test protein, a 10 nM solution in PBST of the highly basic U1A RNA-binding protein was injected into another channel. Interactions of the labeled protein with the surface were detected with real-time single-molecule TIRF microscopy (objective type). Briefly, fluorescence was excited with 532 nm laser (Coherent Verdi; continuous wave, transverse electromagnetic mode 00) at 20 mW illuminating an area on the glass of ˜100 microns in diameter. Fluorescence was collected with a 60× 1.49 NA oil objective (Olympus), passed through a 532 nm Raman filter, a 580/60 nm band pass filter, and focused onto a 512×512 pixel back-illuminated EMCCD camera (Andor Technologies) at a ˜80× magnification. Fluorescence was imaged at a video frame rate of 300 ms per frame, at a 3 MHz readout rate without electron multiplication. The average number of fluorescent protein spots present in a newly exposed area was counted.

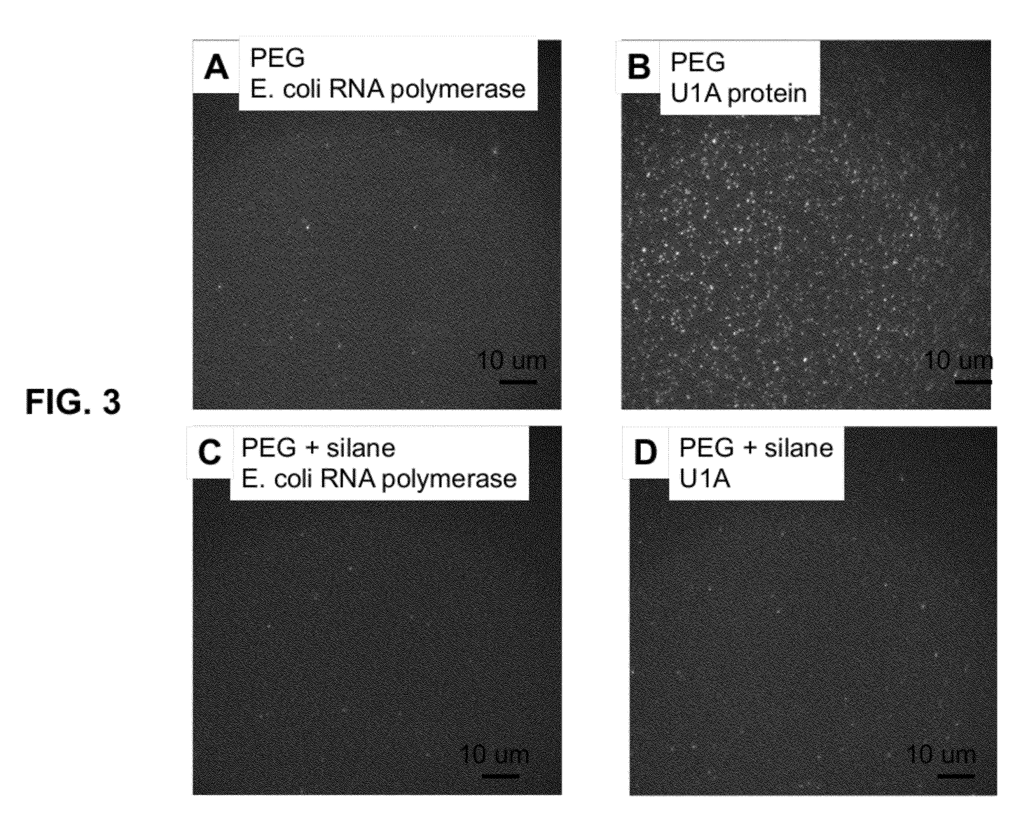

FIGS. 3A and 3B show representative TIRF images of coverslips modified with PEG alone, incubated with 10 nM labeled RNA polymerase (A) and with 10 nM labeled basic protein U1A (B). Comparison of FIGS. 3A and 3B shows that a PEG-treated surface is benign with respect to RNA polymerase, but displays 100-fold higher levels of non-specific binding towards the basic protein U1A. The high levels of non-specific binding of U1A may be due to its net positive charge, which is more sensitive to the presence of residual unreacted, negatively charged silanol groups on the PEG-modified surface.

FIGS. 3C and 3D show representative TIRF images of coverslips modified with PEG, followed by 1,7 dichlorooctamethyltetrasiloxane treatment, incubated with the same two test proteins. The siloxane-treated surface displays benign behavior towards both RNA polymerase and U1A.

### Example 3

### Characterization of Surface Passivation Using an Activity Decay Assay

The following “transcription activity decay” experiment was used to monitor the loss of activity of factors that make up the RNA polymerase II transcription system. Due to the high complexity of the Pol II system, this assay is very sensitive to the quality of surface passivation and can be similarly applied to other complex systems.

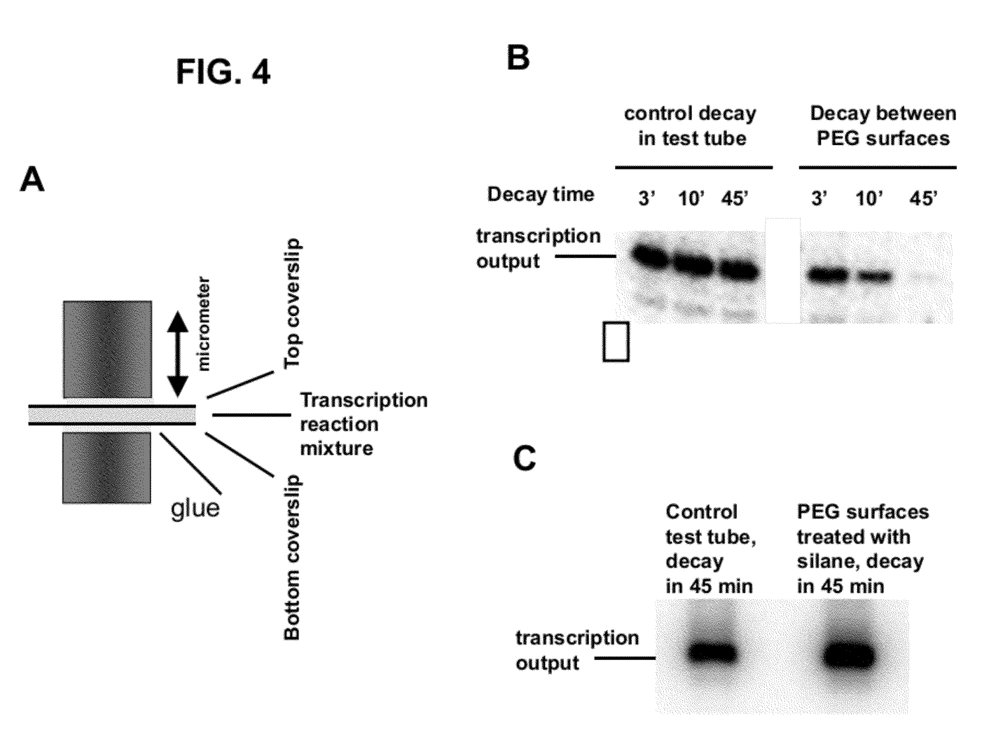

A “surface decay machine” shown in FIG. 4A was set up to measure transcription activity decay between two modified glass cover slips as follows: (1) the bottom glass coverslip was glued to a stationary base with an adhesive, with the passivated side facing up; (2) the top glass coverslip, with the passivated side facing down, was placed above the bottom coverslip, and glued to a support that can be moved up and down with a micrometer. The resulting even narrow space between the two coverslips holds the “transcription reaction mixture” for the decay assay (see below for the details of the transcription mixture). Typically, a volume of 80 μl of reaction mixture in between two 40×25 mm cover slips was used. The micrometer allows for accurate surface/volume ratio control and easy recovery of the mixture when the incubation is finished. To monitor the loss of transcription activity between the surfaces, DNA template was not included in the transcription reaction mixture. At the end of incubation, 26.5 μl of the mixture was recovered and added to a standard test tube containing a reporter DNA template, which contains a strong Pol II promoter and produces a specific transcript. This mixture was then incubated at 30° C. for 45 minutes to monitor the transcription activity left after the decay incubation. The transcription products were then detected and quantified by a well documented primer-extension method.

FIG. 4B shows the results of the significant and progressive activity decay in the RNA polymerase II transcription mixture during the incubation between two coverlsips modified only with the PEG. There was no significant loss of activity during incubation in the control (Eppendorf) tubes.

FIG. 4C shows the results of the activity decay in the RNA polymerase II transcription mixture after 45 min of incubation between two coverslips modified with the passivation method described herein. No significant loss of activity was observed in comparison to the reaction in the tube control.

### Example 4

### Characterization of Surface Passivation by Measuring Transcription Activity on Surface-Immobilized DNA Templates

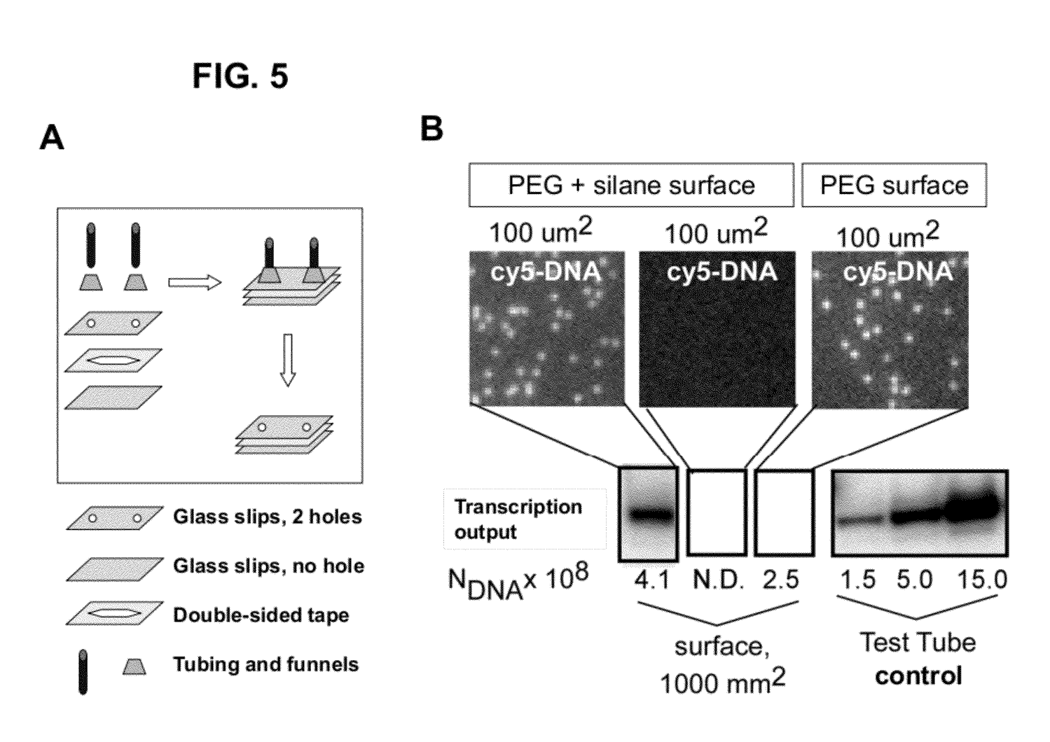

A “single-molecule biochemistry chamber” that enables monitoring of transcription activity on immobilized DNA templates is shown in FIG. 5A. Briefly, a set of cover slips having two laser-drilled holes was passivated according to the disclosure, alongside undrilled cover slips. A sandwich consisting of an un-drilled, and a drilled coverslip was prepared using double-sided silicon Scotch tape (0.1 mm thickness) with the central area removed by a razor blade (the central area is about 5 cm²). A plastic polyether ether ketone (PEEK) adapter and a short PEEK tube were glued to each hole. It is noted that the tape, the adapter, and the tube were tested for transcription activity decay and were found to be benign. The HPLC tubes and ferrules facilitated the initial exchanges of solutions. Fluorescently labeled DNA templates were immobilized on the surface to a density of roughly 1000-4000 molecules per 100×100 micron area using single-molecule TIRF imaging to control the amount of DNA. The transcription reaction mixture was then injected, the ferrules and tubes were peeled off, and the reaction was allowed to proceed for ˜45 min. The RNA produced from the surface-immobilized DNA was then recovered with the transcription “stop” solution” (see below). In parallel, defined amounts of DNA templates (calculated based on the 10 mm² total surface area of the chamber and the density of DNA templates per surface obtained by single-molecule imaging) were transcribed in a test tube to provide a “calibration curve” of activity in optimal conditions.

The comparison of transcription activity on the surface with the activity in the test tube shown in FIG. 5B indicates that the transcription activity from DNA templates immobilized on the passivated surface was in a quantitative agreement with the activity in the test tube.

### Example 5

### Transcription Reaction Mixture

A volume of 27.5 microliter reaction contained the following components: 0.36 nM DNA template (a 300˜500 bp long PCR product containing a strong promoter followed by a unique sequence), 5 ng TFIIB, 20 ng TFIIE-34, 20 ng TFIIE-56, 20 ng TFIIF, 10˜50 ng TFIID, ˜5 ng TFIIH, ˜10 ng Pol II, 4.5% glycerol, 11.4 mM HEPES pH 7.9, 5.7 mM MgCl₂, 45 mM EDTA, 1.8 mM Spermidine (Sigma-Aldrich), 100 ng yeast tRNA (Sigma-Aldrich), 0.45 mM trolox (Sigma-Aldrich®), 1.14 mM 3,4-Dihydroxybenzoic acid (Sigma-Aldrich®), 8 U recombinant RNasin® (Promega), 1.25 μg Bovine Serum Albumin (New England Biolabs), 0.08% Tween 20 (EMD Chemicals), 0.0045% NP40 (EMD Chemicals). The general transcription factors TFIIB, E, and F were recombinantly expressed and purified from E. coli. The TFIID, TFIIH and Pol II were affinity purified from Hela nuclear/chromatin extract. The transcription incubation was at 30° C. for 45 minutes and was stopped with 100 μl of “stop solution” (20 mM EDTA, 1% SDS, 0.2 M NaCl, 0.25 μg/μl yeast tRNA, and 40 μg/ml Proteinase K) and incubated at 37° C. for 10 minutes. The transcription product was extracted and detected by a routine primer extension assay.

What is claimed is:

1. A method for passivating a surface for single molecule imaging, the method comprising contacting the surface with an effective amount of a hydrophobic organosilane/siloxane for a time sufficient to passivate the surface for single molecule imaging.

2. The method of claim 1, wherein the surface is selected from the group consisting of a slide, coverslip, plate, chip, sphere, microparticle, bead, microwell, and microfluidic device.

3. The method of claim 1, wherein the hydrophobic organosilane/siloxane is selected from the group consisting of 1,7-dichlorooctamethyltetrasiloxane, tert-butyltrichlorosilane, 1,3-dichlorotetramethyldisiloxane, butyltrichlorosilane, dichlorodimethylsilane, trimethylchlorosilane, butyltrichlorosilane, tert-butyltrichlorosilane, octadecyltrichlosilane, dichlorodimethylsilane, and 1,5-dichlorohexamethyltrisiloxane.

4. The method of claim 1, wherein the hydrophobic organosilane/siloxane is 1,7-dichlorooctamethyltetrasiloxane.

5. The method of claim 1, wherein the effective amount of the hydrophobic organosilane/siloxane is about 1% to about 50% in solution.

6. The method of claim 1, wherein the time sufficient to passivate the surface for single molecule imaging is between 6 hours and 24 hours.

7. The method of claim 1, further comprising contacting the surface with a blocking reagent.

8. The method of claim 7, wherein the blocking reagent comprises one or more agents selected from the group consisting of Tween20, Triton X-100, bovine serum albumin, lysozyme, non-fat milk, serum extracts, and cellular extracts.

9. A method of imaging a biochemical reaction comprising:
contacting an imaging surface with an effective amount of a hydrophobic organosilane/siloxane for a time sufficient to passivate the surface for single molecule imaging;
attaching at least a first component of the biochemical reaction to the surface;
reacting at least the first component of the biochemical reaction with a second component; and
imaging the biochemical reaction.

10. The method of claim 9, wherein the surface is further treated with a blocking reagent prior to attaching the first component.

11. The method of claim 9, wherein the first component of the biochemical reaction is attached to the imaging surface through a covalent linkage.

12. The method of claim 11, wherein the covalent linkage is a bond between biotin and streptavidin.

13. The method of claim 12, wherein the surface comprises biotin and the first component comprises streptavidin.

14. The method of claim 9, wherein the second component comprises a detectable label selected from the group consisting of fluorophores, fluorescent proteins, quantum dots, metal nanoclusters and macroscopic tags.

15. The method of claim 14, wherein the detectable label is a fluorophore.

16. The method of claim 9, wherein the biochemical reaction is imaged using a method selected from the group consisting of epifluorescence microscopy, confocal microscopy, total-internal-reflection fluorescent microscopy, pseudo-total internal-reflection fluorescent microscopy, zero-mode waveguide-based imaging, near-field optical microscopy, bright-field microscopy, super-resolution microscopy, and atomic force microscopy

17. The method of claim 9, wherein the first component comprises nucleic acids and the second component comprises human RNA Polymerase II (Pol II).

18. A kit for use in a method for single molecule imaging of a biochemical reaction, wherein the kit comprises a hydrophobic organosilane/siloxane and instructions for using an effective amount of the hydrophobic organosilane/siloxane for a time sufficient to passivate a surface for single molecule imaging.

19. The kit of claim 18, further comprising a solid surface.
